(19) United States
(12) Patent Application Publication
(10) Pub. No.: US 2008/0230324 A1
(43) Pub. Date: Sep. 25, 2008

(54) Frangible Buffer For An Elevator System With Multiple Cars In A Hoistway

(76) Inventors: John Ferrisi, Southington, CT (US); Richard McCarthy, Simsbury, CT (US)

Correspondence Address: CARLSON GASKEY & OLDS, 400 W MAPLE STE 350, BIRMINGHAM, MI, 48009, US

(21) Appl. No.: 12/067,179

(22) PCT Filed: Sep. 29, 2005
(86) PCT No.: PCT/US05/34855

§ 371 Date: Mar. 18, 2008

(51) Int. Cl. B66B 5/28

(52) U.S. Cl. 187/343

(57) ABSTRACT

An elevator system (20) includes multiple elevator cars (22, 32) within a hoistway (26). Counterweights (24, 34) are associated with the respective elevator cars (22, 32). Frangible buffers (40, 38) are associated with at least one of the elevator cars (22, 32), the counterweights (24, 34) or both. In a disclosed example, buffer activators (42, 39) operate to break at least a frangible portion of the frangible buffers (40, 38) to dissipate energy associated with a collision or near collision between the elevator cars (22, 32) or the counterweights (24, 34).

### FIELD OF THE INVENTION

This invention generally relates to elevator systems. More particularly, this invention relates to a buffer arrangement for use in an elevator system having more than one car in a hoistway.

### DESCRIPTION OF THE RELATED ART

Many elevator systems include a car and counterweight coupled together by a rope or other load bearing member. A machine controls movement of the car to service passengers between various levels in a building, for example. As known, the counterweight and car typically move in opposite directions within a hoistway.

It has been proposed to include multiple elevator cars within a single hoistway. Such an arrangement provides advantages for increased or improved passenger service, for example. Example patents pertaining to elevator systems having multiple cars within a hoistway include U.S. Pat. Nos. 1,837,643; 1,896,776; 5,419,414; 5,584,364; and the published application U.S. 2003/0075388. Each of these shows a different arrangement of components within such an elevator system.

There are various challenges presented when trying to provide multiple cars in a hoistway. For example, it is necessary to control movement of the system components to avoid collisions between the elevator cars. Regardless of the system design, it is necessary to provide for the possibility that there may be a collision between the elevator cars or counterweights. In particular, there is a need to incorporate a buffer to absorb energy associated with a collision between the cars or the counterweights.

Elevator systems typically include a buffer located at the bottom of a hoistway or within a pit. Conventional elevator system buffers typically are spring-based. Coil springs or oil filled cylinders absorb energy associated with an elevator car or counterweight traveling toward the bottom of a hoistway in an undesirable manner when a governor or a braking device is unable to control downward movement of the car or counterweight. Conventional elevator system buffers are relatively large, heavy and expensive. Therefore, it is not desirable to incorporate a conventional buffer arrangement into an elevator system having two cars within a hoistway for absorbing energy associated with a potential collision between the cars or the counterweights.

There is a need for an effective and economical arrangement for providing energy-absorbing capabilities within an elevator system having two cars within a hoistway in the event of a collision between the cars or the counterweights. This invention addresses that need.

### SUMMARY OF THE INVENTION

An exemplary disclosed elevator system includes a first elevator car supported for vertical movement in a hoistway. A second elevator car below the first elevator car moves vertically within the hoistway independent of the first elevator car. At least one frangible buffer supported on at least one of the elevator cars at least partially break to absorb energy associated with contact between the frangible buffer and a corresponding portion associated with the other elevator car.

In one example, at least one buffer activator is supported on the other elevator car for breaking a frangible portion of the frangible buffer upon contact with the frangible buffer.

One example includes a plurality of frangible buffers and a plurality of buffer activators supported on the elevator cars, respectively.

The disclosed example frangible buffer arrangement effectively and economically absorbs energy in the event of a collision or near collision of the elevator cars or counterweights in an elevator system having more than one elevator car in a hoistway.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected components of an elevator system having more than one elevator car in a hoistway and frangible buffers.

FIG. 2 schematically illustrates one example frangible buffer and activator configuration.

### DETAILED DESCRIPTION OF THE PREFERRED EMBODIMENTS

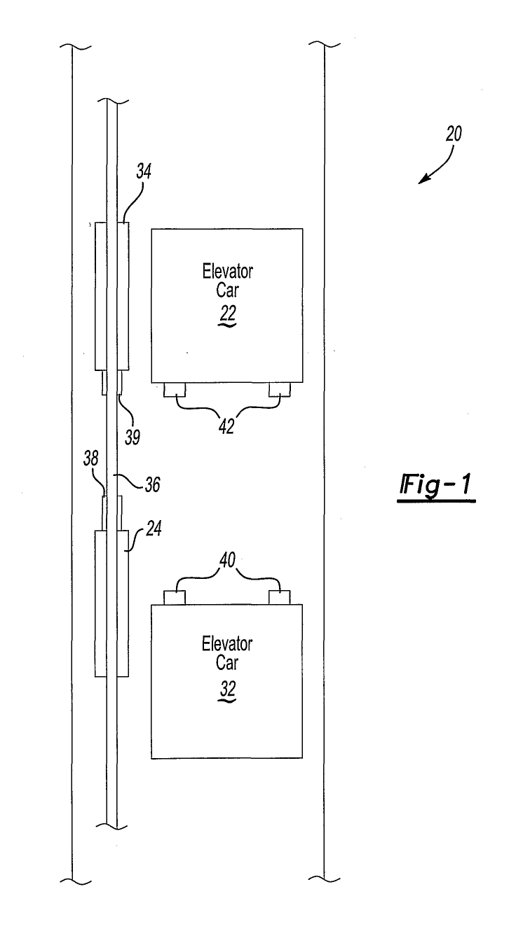

FIG. 1 schematically shows selected portions of an elevator system 20. A first elevator car 22 is coupled with a first counterweight 24 for simultaneous movement within a hoistway 26. Although not shown in FIG. 1, the first elevator car 22 is coupled to the first counterweight 24 by a plurality of ropes or belts as known. A second elevator car 32 is positioned below (according to the drawing) the first elevator car 22. The second elevator car 32 is associated with a second counterweight 34 so that both move within the hoistway 26 as known.

In this example, the counterweights 24 and 34 travel along common guiderails 36. In other words, the counterweights 24 and 34 share the same guiderails.

Another feature of the system 20 schematically shown in FIG. 1 is that at least one frangible buffer 38 is supported on at least one of the counterweights 24 and 34 to absorb impact associated with the counterweights contacting each other. The other counterweight, which in this example is the second counterweight 34, includes a buffer activator 39 that interacts with the frangible buffer 38 in the event that the counterweights 24 and 34 collide or nearly collide, for example. The buffer activator 39 operates to break at least a frangible portion of the frangible buffer 38 for dissipating energy associated with the movement of the counterweights 24 and 34 toward each other as they approach a collision or near collision.

In the example of FIG. 1, the second elevator car 32 includes a plurality of frangible buffers 40 facing toward the first elevator car 22. A corresponding plurality of buffer activators 42 are supported on the first elevator car 22.

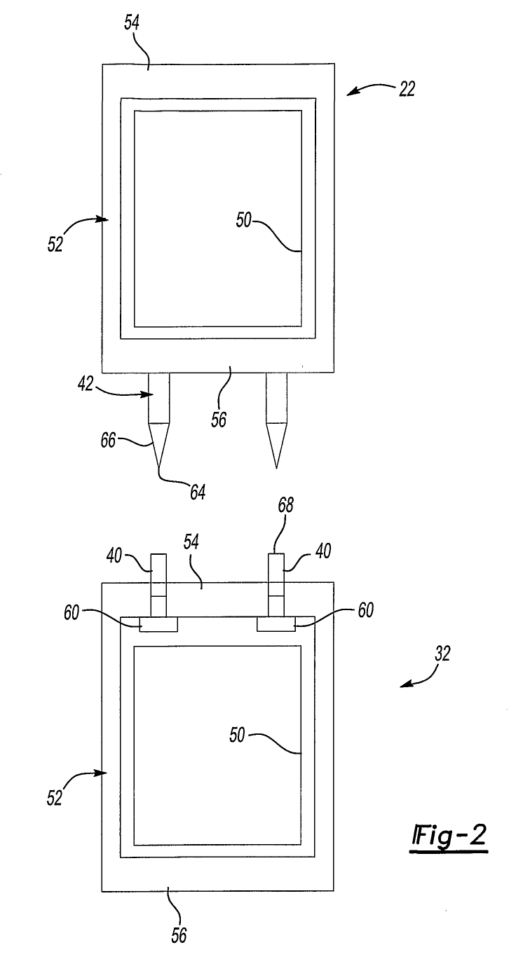

FIG. 2 schematically shows one example arrangement having a plurality of frangible buffers 40 supported on one elevator car 32 and a corresponding plurality of buffer activators 42 supported on the other elevator car 22. As schematically shown in FIG. 2, each elevator car includes a cabin 50 supported in a known manner on a frame 52. The frames 52 and their various members are conventional. Each frame 52 includes crosshead beams 54 and plank beams 56, as known.

In the illustrated example, the frangible buffers 40 include buffer supports 60 that are supported by the crosshead beams 54 of the second elevator car 32. In this example, the frangible portions of the frangible buffers 40 extend upward and beyond the crosshead beams 54. The buffer activators 42 are supported near the plank beams 56 of the frame 52 of the first elevator car 22. In one example, the buffer activators 42 are at least partially supported between two plank beams 56. Of course, the frangible buffers 40 and the buffer activators 42 could be reversed so that they are each supported on the other elevator car. Another example includes at least one buffer on each car and at least one corresponding buffer activator on each car.

The example buffer activators 42 have a plunger with a distal end 64 and a wedge portion 66. In this example, the distal ends 64 are capable of piercing through a distal surface 68 on the frangible buffers 40 upon contact between the buffer activators 42 and the frangible buffers 40 with sufficient force. The wedge portions 66 then operate to progressively split the frangible buffers 40 as the elevator cars 22 and 32 progressively move closer together. Breaking the frangible buffers 40 and progressively deforming them dissipates energy associated with the collision or near collision between the elevator cars 22 and 32.

The frangible buffers 40 in one example are a single-use device such that they would be disposable and replaced in the event that they become at least partially broken by interaction with a corresponding buffer activator 42. Given that the expectation of collision or near collision between the elevator cars or counterweights is minimal, there should be minimal replacement of the frangible buffers. Therefore, the example frangible buffer arrangement provides a far more economical approach than is available using conventional coil spring or hydraulic elevator buffers, such as those typically found in an elevator pit.

Another economical advantage provided by this example is that it eliminates any need for checking or electrical monitoring of buffer readiness. Hydraulic buffers must be periodically inspected or electrically monitored to validate oil fill level and piston position status as confirmations that the buffer is ready to operate. Such monitoring becomes undesirably expensive if a hydraulic buffer were mounted on a counterweight, for example. A frangible buffer as used in this example provides the ability for a simple visual inspection to confirm that the operative portion of the buffer is intact, which is much less costly.

In one example, the frangible buffers 40 include metal tubes that split into at least two portions responsive to interaction with the buffer activators 42. In one example, the buffer activators 42 should be replaced each time that a frangible buffer is replaced.

The counterweight buffer 38 and buffer actuator 39 in one example are basically the same as those used on the elevator cars. Some examples include different buffer types on the cars compared to those used on the counterweights.

Given this description, those skilled in the art will realize what materials and what configuration will best meet their needs for providing a frangible buffer in an elevator system having multiple cars within a hoistway.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator system, comprising:
a first elevator car supported for vertical movement in a hoistway;
a second elevator car below the first elevator car and supported for vertical movement in the hoistway independent of the first elevator car; and
at least one frangible buffer supported on at least one of the elevator cars for at least partially breaking to absorb energy associated with contact between the frangible buffer and a corresponding portion associated with the other elevator car.

2. The elevator system of claim 1, including at least one buffer activator supported on the other elevator car for breaking a frangible portion of the frangible buffer upon contact with the frangible buffer.

3. The elevator system of claim 2, including a plurality of the frangible buffers and a corresponding plurality of the buffer activators.

4. The elevator system of claim 2, wherein the buffer activator has a plunger for progressively breaking more of the frangible portion as the elevator cars progressively move closer together if there is contact between the frangible buffer and the buffer activator.

5. The elevator system of claim 1, wherein each elevator car includes a frame having a crosshead beam along a top of the frame and a plank beam along a bottom of the frame and wherein the frangible buffer is supported near one of the crosshead beam of the second elevator car or the plank beam of the first elevator car.

6. The elevator system of claim 5, including a buffer activator supported near one of the plank beam of the first elevator car or the crosshead beam of the second elevator car for breaking at least a frangible portion of the frangible buffer if there is contact between the buffer activator and the frangible buffer.

7. The elevator system of claim 1, comprising
a first counterweight in the hoistway coupled with the first elevator car to move simultaneously with the first elevator car;
a second counterweight in the hoistway above the first counterweight, the second counterweight is coupled with the second elevator car to move simultaneously with the second elevator car; and
at least one frangible counterweight buffer supported on at least one of the counterweights for at least partially breaking to absorb energy associated with contact between the frangible counterweight buffer and a corresponding portion associated with the other counterweight.

8. The elevator system of claim 7, including a buffer activator supported on the other counterweight for breaking a frangible portion of the frangible counterweight buffer if there is contact between the buffer activator and the frangible counterweight buffer.

9. An elevator system, comprising:
a first elevator car supported for vertical movement in a hoistway;
a first counterweight in the hoistway coupled with the first elevator car to move simultaneously with the first elevator car;
a second elevator car below the first elevator car and supported for vertical movement in the hoistway independent of the first elevator car;
a second counterweight in the hoistway above the first counterweight, the second counterweight is coupled with the second elevator car to move simultaneously with the second elevator car; and
at least one frangible buffer supported on at least one of the elevator cars or one of the counterweights for at least partially breaking to absorb energy associated with contact between the frangible buffer and a corresponding portion associated with the other elevator car or the other counterweight.

10. The elevator system of claim 9, including at least one buffer activator supported on the other elevator car or the other counterweight for breaking a frangible portion of the frangible buffer upon contact with the frangible buffer.

11. The elevator system of claim 10, including a plurality of the frangible buffers and a corresponding plurality of the buffer activators.

12. The elevator system of claim 10, wherein the buffer activator has a plunger for progressively breaking more of the frangible portion as the elevator cars or the counterweights progressively move closer together if there is contact between the frangible buffer and the buffer activator.

13. The elevator system of claim 9, including at least one frangible buffer on at least one of the elevator cars and at least one other frangible buffer on at least one of the counterweights.

14. The elevator system of claim 9, including a plurality of the frangible buffers on the at least one elevator car.
